(19) United States
(12) Patent Application Publication
(10) Pub. No.: US 2025/0260109 A1
(43) Pub. Date: Aug. 14, 2025

(54) COMPRESSION PADS FOR BATTERY MODULES

(71) Applicant: Caterpillar Inc., Peoria, IL (US)

(72) Inventors: Andrew Douglas Steinmetz, Mapleton, IL (US); Hiep Thi-Ngoc Pham, Pekin, IL (US)

(73) Assignee: Caterpillar Inc., Peoria, IL (US)

(21) Appl. No.: 18/436,082

(22) Filed: Feb. 8, 2024

(51) Int. Cl. H01M 50/242; H01M 50/209; H01M 50/211; H01M 50/218; H01M 50/249

(52) U.S. Cl. CPC H01M 50/242; H01M 50/218; H01M 50/249; H01M 50/209; H01M 50/211; H01M 2220/20

(57) ABSTRACT

A compression pad for pressurizing an outer surface of at least one energy storage cell is disclosed. The at least one energy storage cell exhibits alternating high-pressure and low-pressure regions across the outer surface under a loading. The compression pad includes a body that defines a corrugated surface. The corrugated surface includes alternating protrusion portions and depression portions. The corrugated surface contacts the outer surface and aligns with a natural frequency of pressure distribution across the outer surface such that the protrusion portions exert relatively higher loads correspondingly on the low-pressure regions and the depression portions exert relatively lower loads correspondingly on the high-pressure regions to uniformly pressurize the outer surface under the loading.

### TECHNICAL FIELD

The present disclosure relates to battery modules in work machines. More particularly, the present disclosure relates to a compression pad for controlling pressure distribution across outer surfaces of at least one energy storage cell stored within a battery module.

### BACKGROUND

Work machines, such as wheel loaders and the like machines, are generally equipped with battery modules for powering operations of the work machines. A battery module typically includes a housing and multiple energy storage cells, such as lithium-ion prismatic (or pouch) cells. The energy storage cells are generally stacked side-by-side (i.e., a face of one energy storage cell is adjacent to a face of another energy storage cell) within the housing.

The energy storage cells stacked within the housing are compressed (pressurized, or preloaded) together, for example, via flat end plates of the housing, to secure the energy storage cells therewithin and/or to ensure ideal performance and life of the energy storage cells. As the energy storage cells tend to swell over their useable life, for example, due to temperature, age, state of a charge, or charging and discharging of the energy storage cells, it may be difficult to compress the energy storage cells uniformly across surfaces of the energy storage cells.

Chinese patent no. 213,278,241 discloses a magnesium power generation device. The magnesium power generation device includes a shell and a battery core assembly fixedly arranged in the shell. The battery core assembly includes a battery core and elastic buffer layers. The battery core includes a metal copper plate, a catalytic layer, a water absorbing layer, and a metal magnesium plate stacked in sequence. The elastic buffer layers are fixedly arranged on upper surface and lower surface of the battery core and a gap is formed between the elastic buffer layer and at least one inner wall surface of the shell.

### SUMMARY OF THE INVENTION

In one aspect, the disclosure relates to a compression pad for pressurizing an outer surface of at least one energy storage cell. The at least one energy storage cell exhibits alternating high-pressure and low-pressure regions across the outer surface under a loading. The compression pad includes a body that defines a corrugated surface. The corrugated surface includes alternating protrusion portions and depression portions. The corrugated surface is configured to contact the outer surface and align with a natural frequency of pressure distribution across the outer surface such that the protrusion portions exert relatively higher loads correspondingly on the low-pressure regions and the depression portions exert relatively lower loads correspondingly on the high-pressure regions to uniformly pressurize the outer surface under the loading.

In another aspect, the disclosure is directed to a battery module for a work machine. The battery module includes a housing, at least one energy storage cell, and a compression pad. The at least one energy storage cell is disposed within the housing. The at least one energy storage cell defines an outer surface and exhibits alternating high-pressure and low-pressure regions across the outer surface under a loading. The compression pad is configured to pressurize the outer surface of the at least one energy storage cell under the loading. The compression pad includes a body. The body defines a corrugated surface. The corrugated surface includes alternating protrusion portions and depression portions. The corrugated surface is configured to contact the outer surface and align with a natural frequency of pressure distribution across the outer surface such that the protrusion portions exert relatively higher loads correspondingly on the low-pressure regions and the depression portions exert relatively lower loads correspondingly on the high-pressure regions to uniformly pressurize the outer surface under the loading.

In yet another aspect, the disclosure relates to a method for controlling pressure distribution across an outer surface of at least one energy storage cell of a battery module. The at least one energy storage cell exhibits alternating high-pressure and low-pressure regions across the outer surface under a loading. The method includes positioning a compression pad within the battery module. The compression pad includes a body. The body defines a corrugated surface. The corrugated surface includes alternating protrusion portions and depression portions. The compression pad is positioned in a way that the corrugated surface contacts the outer surface and aligns with a natural frequency of pressure distribution across the outer surface such that the protrusion portions exert relatively higher loads correspondingly on the low-pressure regions and the depression portions exert relatively lower loads correspondingly on the high-pressure regions to uniformly pressurize the outer surface under the loading.

### BRIEF DESCRIPTION OF THE DRAWINGS

FIG. 1 is a side view of an exemplary work machine including a battery module, in accordance with an embodiment of the present disclosure;

FIG. 2 is a perspective view of the battery module including a housing and multiple energy storage cells packed within the housing, in accordance with an embodiment of the present disclosure;

FIG. 3 is a side exploded view of the battery module, with a side plate of the housing of the battery module removed, in accordance with an embodiment of the present disclosure;

FIG. 4 is a side view of a first compression pad disposed within the battery module, in accordance with an embodiment of the present disclosure;

FIG. 5 is an exploded view of a portion of the battery module depicting the first compression pad disposed between two neighboring energy storage cells of the battery module, in accordance with an embodiment of the present disclosure;

FIG. 6 is a side view of a second compression pad disposed within the battery module, in accordance with an embodiment of the present disclosure; and

FIG. 7 is an exploded view of a portion of the battery module depicting the second compression pad disposed between an energy storage cell and a flat end plate of the housing, in accordance with an embodiment of the present disclosure; and

FIG. 8 illustrates an exemplary pressure distributions across an outer surface of the energy storage cell compressed under a loading within the battery module, in accordance with an embodiment of the present disclosure.

### DETAILED DESCRIPTION

Reference will now be made in detail to specific embodiments or features, examples of which are illustrated in the accompanying drawings. Generally, corresponding reference numbers may be used throughout the drawings to refer to the same or corresponding parts, e.g., 1, 1′, 1″, 101 and 201 could refer to one or more comparable components used in the same and/or different depicted embodiments.

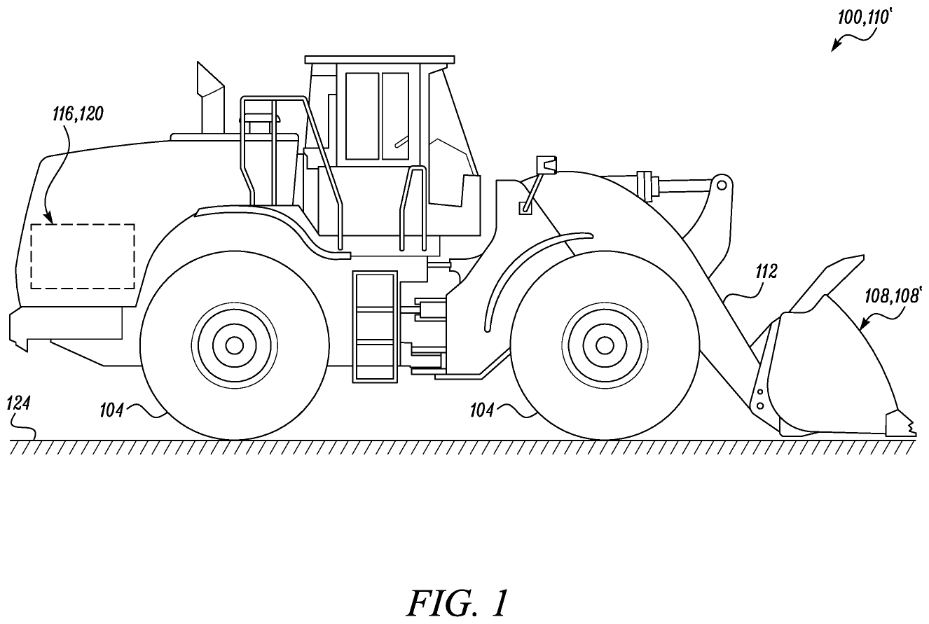

Referring to FIG. 1, a machine 100 is illustrated. As exemplarily depicted, the machine 100 includes a loader machine, such as a wheel loader 100′. However, it may be contemplated that the machine 100 may be of any type which may be configured to perform operations associated with an industry, such as, mining, construction, farming, and transportation. An application of one or more aspects of the present disclosure may be extended to stationary machines, such as generator sets, as well. Therefore, it will be appreciated that references to the machine 100 is exemplary. Other examples of machine 100 may include, but are not limited to, an off-highway truck, an articulated truck, a paver, an excavator, a backhoe loader, a skid steer loader, a compactor. As shown in FIG. 1, the machine 100 includes ground engaging members 104 (such as, wheels 104), an implement 108 (such as, a bucket 108′), and a pair of movable lift arms 112 that may be applied to manipulate the implement 108.

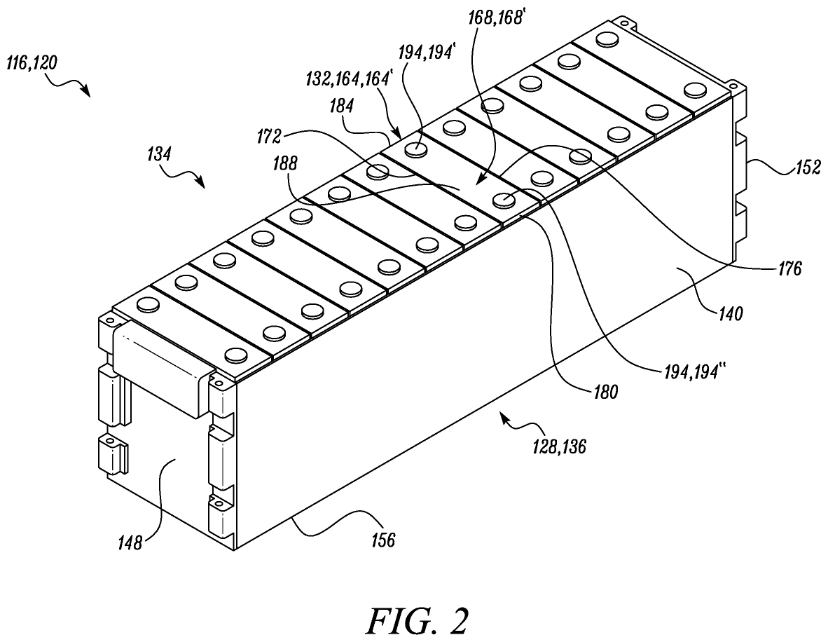

The machine 100 may include a power source 116 that may provide power to operate the machine 100. The power source 116 may include one or more battery modules, such as a battery module 120 (shown in FIG. 2). In an example, the battery module 120 may supply power to the ground engaging members 104, for example, to move the machine 100 over a ground surface 124. The battery module 120 may also be used to supply power to operate the implement 108 and perform various other operations of the machine 100. In some embodiments, the battery module 120 may work in conjunction with one or more additional power sources (not shown), such as an internal combustion engine, an electric generator, a turbine, or any other suitable device, by which power may be produced and then supplied to perform one or more of the operations of the machine 100.

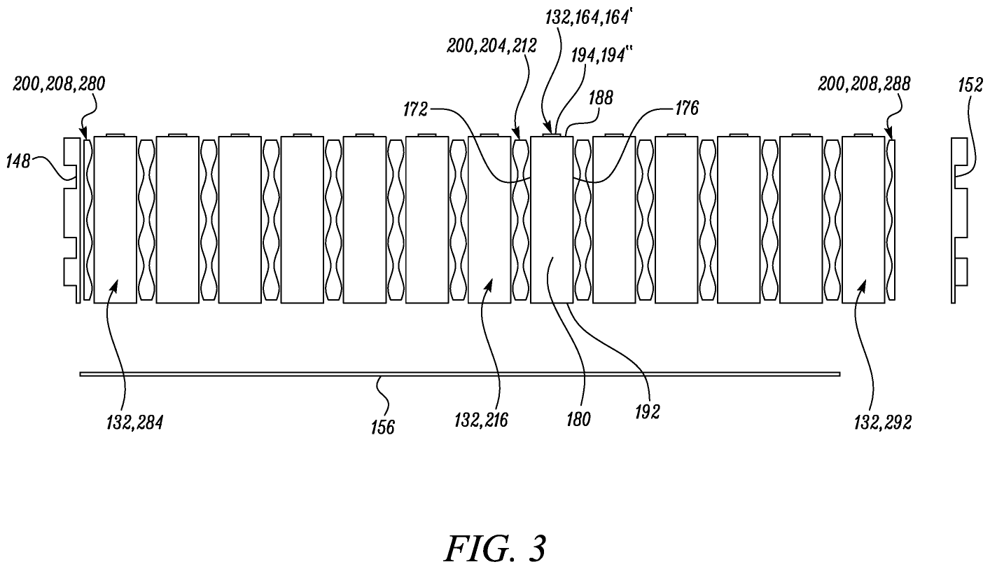

Referring to FIGS. 2 and 3, the battery module 120 is discussed. The battery module 120 includes a housing 128 and multiple energy storage cells 132 (discussed below). The battery module 120 may also include electrical and/or electronic components, such as busbars, a battery management system, and the like. It should be noted that construction and functionality of such electrical and/or electronic components are known in the art, and therefore, they are not discussed.

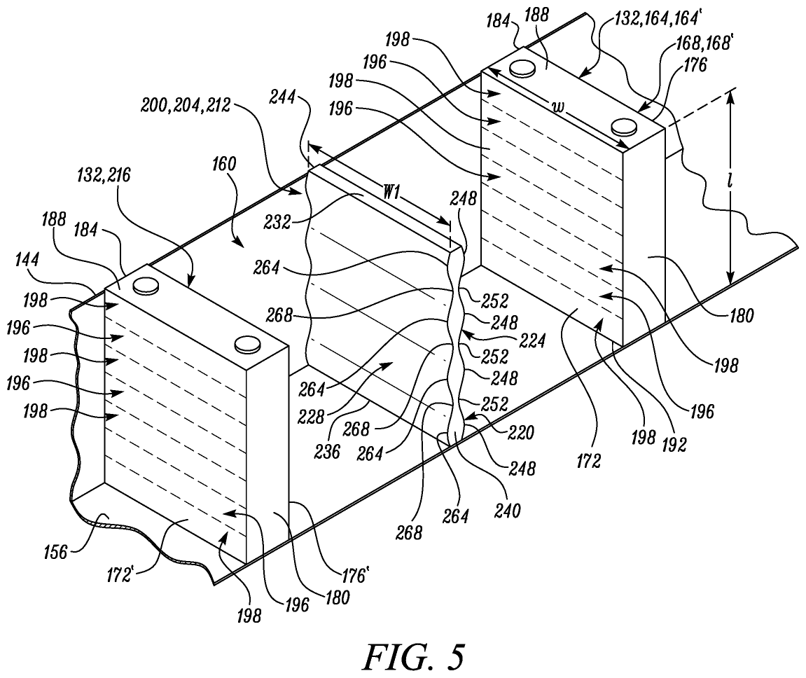

The housing 128 may be embodied as a substantially cuboid shaped structure 136. The cuboid shaped structure 136 may be formed of multiple plates, namely—a pair of side plates (i.e., a first side plate 140, and a second side plate 144, shown in FIG. 5), a pair of end plates (i.e., a first end plate 148, and a second end plate 152), and a base plate 156. The first side plate 140 and the second side plate 144 may extend parallel to one another. In addition, the first side plate 140 and the second side plate 144 may extend at an angle from the base plate 156, for example, upright with respect to the base plate 156, to define respective sides of the housing 128.

The first end plate 148 and the second end plate 152 may extend parallel to one another. In addition, the first end plate 148 and the second end plate 152 may extend upright with respect to the base plate 156. Furthermore, the first end plate 148 and the second end plate 152 may be coupled to respective ends of the first side plate 140 and the second side plate 144 to define respective ends of the housing 128. In some embodiments, the first end plate 148 and the second end plate 152 may be flat end plates. The first side plate 140, the second side plate 144, the first end plate 148, the second end plate 152, and the base plate 156 may be arranged (or coupled) together to define and surround an interior volume 160 (shown in FIG. 5) of the housing 128. Alternatively, in other embodiments, the base plate 156 may be omitted.

For explanatory purposes, at least one energy storage cell, for example, an energy storage cell 164 of the energy storage cells 132, will now be explained in detail with reference to FIGS. 2 and 3. However, it should be noted that the description provided below for the energy storage cell 164 is equally applicable to the other energy storage cells 132 of the battery module 120 without any limitations.

The energy storage cell 164 may be a prismatic cell 164′. Alternatively, in other embodiments, the energy storage cell 164 may be a pouch cell. Further, the energy storage cell 164 (or the prismatic cell 164) may be an electrochemical cell. Examples of the electrochemical cell may include, but need not be limited to, a lithium-ion cell, such as, a lithium cobalt oxide cell, a lithium manganese oxide cell, a lithium nickel manganese cobalt oxide cell, a lithium iron phosphate cell, a lithium nickel cobalt aluminum oxide cell, and a lithium titanate cell.

The energy storage cell 164 includes a casing 168. Referring to FIGS. 2, 3 and 5, the casing 168 is a cuboid shaped structure 168′ that defines six outer surfaces, namely—a first outer surface 172, a second outer surface 176, a third outer surface 180, a fourth outer surface 184, a fifth outer surface 188, and a sixth outer surface 192. The first outer surface 172 and the second outer surface 176 are relatively larger sides of the casing 168. The first outer surface 172 and the second outer surface 176 may extend parallel to one another. The third outer surface 180, the fourth outer surface 184, the fifth outer surface 188, and the sixth outer surface 192 are relatively shorter sides of the casing 168. The third outer surface 180 and the fourth outer surface 184 may be parallel to one another. The third outer surface 180 and the fourth outer surface 184 may extend between the first outer surface 172 and the second outer surface 176 to connect the first outer surface 172 with the second outer surface 176. The fifth outer surface 188 and the sixth outer surface 192 may be parallel to one another. The fifth outer surface 188 and the sixth outer surface 192 may extend between the first outer surface 172 and the second outer surface 176 to connect the first outer surface 172 with the second outer surface 176. In addition, the fifth outer surface 188 and the sixth outer surface 192 may extend between the third outer surface 180 and the fourth outer surface 184 to connect the third outer surface 180 with the fourth outer surface 184.

Further, the energy storage cell 164 may include one or more electrical tabs 194 (e.g., a positive electrical tab 194′ and a negative electrical tab 194″) for electrically connecting the energy storage cell 164 either with the other energy storage cells 132 of the battery module 120, or with an external electrical circuit(s). In addition, the energy storage cell 164 may include other cell components enclosed within the casing 168. Examples of these cell components include, but may not be limited to, electrodes, separators, and electrolytes. Structures and configurations of these cell components are well known in the art, and therefore, are not discussed.

The energy storage cells 132 are disposed in the interior volume 160 of the housing 128. In an example, as shown in FIGS. 2 and 3, the energy storage cells 132 are disposed side-by-side in a row (i.e., collectively referred to as a stack 134) within the housing 128 such that a first outer surface 172 of one energy storage cell 132 faces a second outer surface 176 of another energy storage cell 132 within the housing 128. Also, in such an arrangement, the first and second outer surfaces 172, 176 of each of the energy storage cells 132 may be parallel to the first end plate 148 and the second end plate 152 of the housing 128. In other embodiments, the housing 128 may accommodate multiple stacks of the energy storage cells 132 (such as the stack 134) arranged in rows and columns.

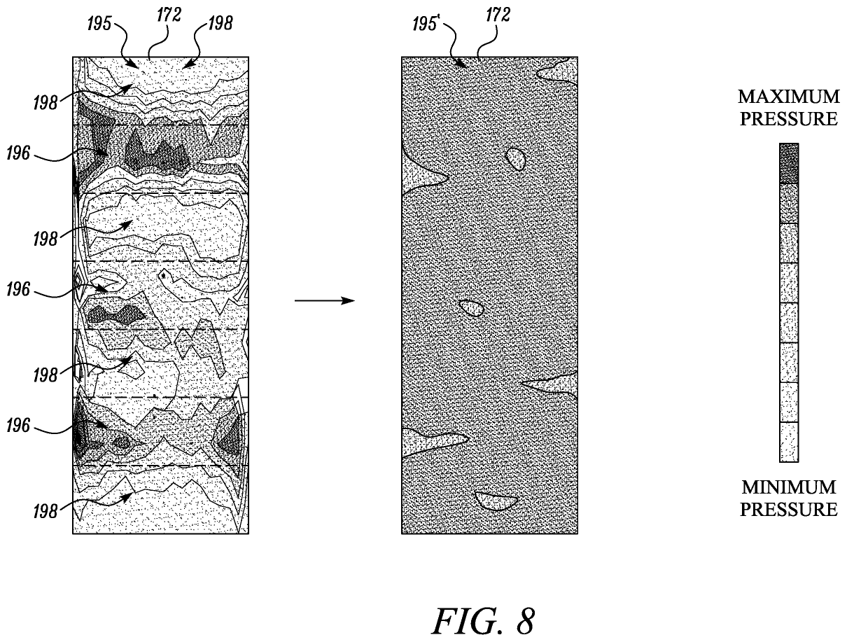

The energy storage cells 132 disposed within the housing 128 are compressed (pressurized, or preloaded) together under a loading. In an example, at least one flat end plates (i.e., the first end plate 148 and the second end plate 152) of the housing 128 may impart the loading on the energy storage cells 132 to compress the energy storage cells 132. However, it is observed that the energy storage cells 132 are not uniformly pressurized, when compressed under such loading. That is, each of the energy storage cells 132 exhibits alternating high-pressure and low-pressure regions (i.e., a natural frequency of pressure distribution, shown as 195 in FIG. 8) across its outer surfaces, when compressed under the loading. For instance, as shown in FIGS. 5 and 8, the energy storage cell 132 (or the energy storage cell 164) exhibits alternating high pressure regions 196 and low-pressure regions 198 across a length ‘l’ of the first outer surface 172 under the loading. Similar to the alternating high-pressure regions 196 and the low-pressure regions 198 across its first outer surface 172, the energy storage cell 132 also exhibits alternating high pressure and low-pressure regions (not shown) across its second outer surface 176 under the loading.

In some embodiments, the energy storage cell 132 (or the energy storage cell 164) exhibits alternating high pressure regions 196 and low-pressure regions 198 across a width ‘w’ of the first outer surface 172 under the loading. In some other embodiments, the energy storage cell 132 (or the energy storage cell 164) exhibits alternating high pressure regions 196 and low-pressure regions 198 across both the length ‘l’ and the width ‘w’ of the first outer surface 172 under the loading.

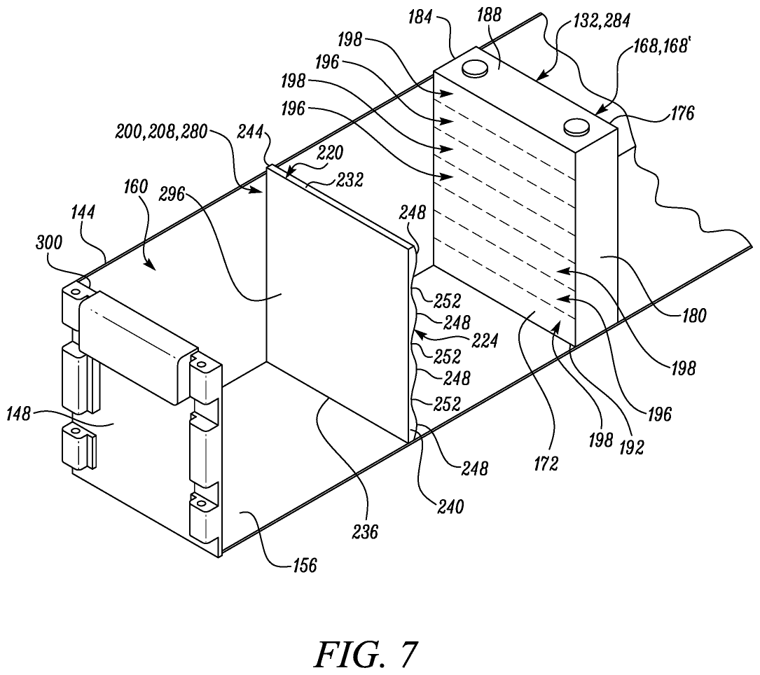

To uniformly pressurize the outer surfaces (i.e., the first outer surface 172 and the second outer surface 176) of the energy storage cells 132 disposed within the housing 128 under the loading, in one or more aspects of the present disclosure, the battery module 120 is provided with one or more compression pads 200. The compression pads 200 include one or more first compression pads 204, each configured to be disposed in-between two neighboring energy storage cells 132, as shown in FIGS. 3 and 5. In addition, the compression pads 200 include one or more second compression pads 208 disposed in-between an outermost energy storage cell 132 (of the energy storage cells 132) and the flat end plate (e.g., the first end plate 148) of the housing 128, as shown in FIGS. 3 and 7.

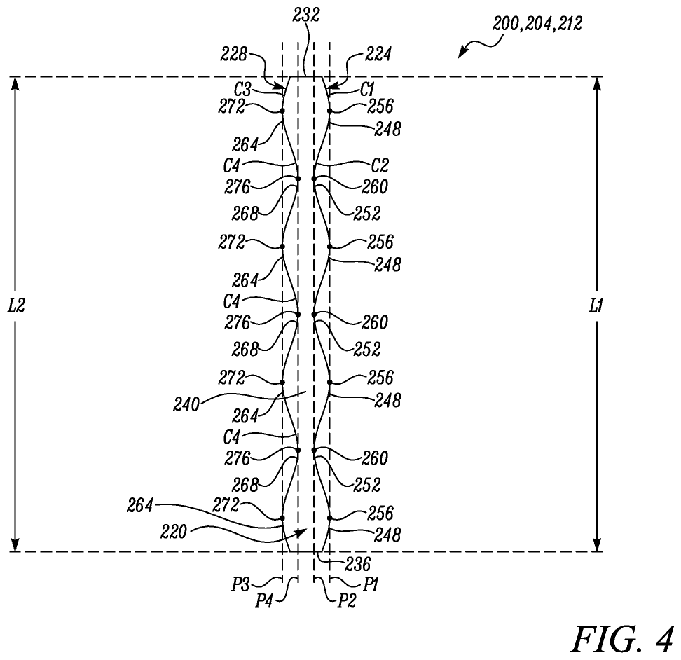

For explanatory purposes, a first compression pad 212 (of the one or more first compression pads 204) disposed in-between two neighboring energy storage cells 132, for example, the energy storage cell 164 (hereinafter referred to as “first energy storage cell 164”) and another energy storage cell 216 (hereinafter referred to as “second energy storage cell 216”) will now be explained in detail with reference to FIGS. 4 and 5. However, it should be noted that the description provided below for the first compression pad 212 is equally applicable to the other first compression pads 204 of the battery module 120, without any limitations.

The first compression pad 212 includes a body 220. The body 220 may be fabricated using foam, plastic, rubber, polymer, or any other suitable compressible and/or non-conductive material. In an exemplary embodiment, the body 220 is fabricated from polyurethane material. The body 220 defines a corrugated surface 224 (hereinafter referred to as “first corrugated surface 224”). Also, the body 220 defines a second corrugated surface 228 opposite to the first corrugated surface 224. Further, the body 220 defines two mutually opposing side surfaces, namely—a first side surface 232 and a second side surface 236 that are perpendicular to the first corrugated surface 224 and the second corrugated surface 228. Furthermore, the body 220 defines two mutually opposing side surfaces, namely—a third side surface 240 and a fourth side surface 244 (shown in FIG. 5) that are perpendicular to the first corrugated surface 224, the second corrugated surface 228, the first side surface 232, and the second side surface 236.

The first corrugated surface 224 includes alternating protrusion portions 248 (hereinafter referred to as “first protrusion portions 248”) and depression portions 252 (hereinafter referred to as “first depression portions 252”) defined across an expanse or a length ‘L1’ of the first corrugated surface 224. It should be noted that the length ‘L1’ is defined between the first side surface 232 and the second side surface 236 of the body 220. Each of the first protrusion portions 248 and the first depression portions 252 may extend longitudinally along a width ‘W1’ defined between the third side surface 240 and the fourth side surface 244.

Each of the first protrusion portions 248 may define a first concavity ‘C1’ that faces towards the body 220 of the first compression pad 212, and each of the first depression portions 252 may define a second concavity ‘C2’ that faces away from the body 220 of the first compression pad 212. Further, the first protrusion portions 248 may define corresponding first crests 256 in a first plane ‘P1’, and the first depression portions 252 may define corresponding first troughs 260 in a second plane ‘P2’. In some embodiments, the first plane ‘P1’ and the second plane ‘P2’ are parallel to each other.

The first corrugated surface 224 is configured to contact the outer surface of the at least one energy storage cell 132. In an example, as shown in FIG. 5, the first corrugated surface 224 is configured to contact the first outer surface 172 of the first energy storage cell 164, when the first compression pad 212 is disposed in-between the first energy storage cell 164 and the second energy storage cell 216. The first corrugated surface 224 contacts the first outer surface 172 in a manner such that a frequency of alternating first protrusion portions 248 and the first depression portions 252 (of the first corrugated surface 224) aligns with the natural frequency of pressure distribution 195 across the first outer surface 172. For example, the first protrusion portions 248 and the first depression portions 252 (of the first corrugated surface 224) are aligned, respectively, with the low-pressure regions 198 and the high-pressure regions 196 of the first outer surface 172. Once aligned in this manner, the first protrusion portions 248 exert relatively higher loads correspondingly on the low-pressure regions 198 and the first depression portions 252 exert relatively lower loads correspondingly on the high-pressure regions 196. By exerting relatively higher loads (via the first protrusion portions 248) and relatively lower loads (via the first depression portions 252), respectively, on the low-pressure regions 198 and the high-pressure regions 196 of the first outer surface 172, the first compression pad 212 may uniformly pressurize the first outer surface 172 (of the energy storage cell 164), under the loading. An exemplary uniform pressure distribution 195′ across the first outer surface 172 of the energy storage cell 164 generated by the application of the first compression pad 212 is disclosed in FIG. 8. The exemplary uniform pressure distribution 195′ may correspond to an even pressure distribution (throughout the first outer surface 172) in which a difference between highs and lows of the pressure distribution is relatively lower than that of the pressure distribution 195 observed without the application of the first compression pad 212.

The second corrugated surface 228 includes alternating protrusion portions 264 (hereinafter referred to as “second protrusion portions 264”) and depression portions 268 (hereinafter referred to as “second depression portions 268”) defined across an expanse or a length ‘L2’ of the second corrugated surface 228. It should be noted that the length ‘L2’ is defined between the first side surface 232 and the second side surface 236 of the body 220, and hence, the length ‘L2’ is equal to the length ‘L1’ of the first corrugated surface 224.

Each of the second protrusion portions 264 and the second depression portions 268 may extend longitudinally between the third side surface 240 and the fourth side surface 244. Each of the second protrusion portions 264 may define a third concavity ‘C3’ that faces towards the body 220 of the first compression pad 212, and each of the second depression portions 268 may define a fourth concavity ‘C4’ that faces away from the body 220 of the first compression pad 212.

Further, the second protrusion portions 264 may define corresponding second crests 272 in a third plane ‘P3’, and the second depression portions 268 may define corresponding second troughs 276 in a fourth plane ‘P4’. In some embodiments, the third plane ‘P3’ and the fourth plane ‘P4’ may be parallel to each other. In some further embodiments, the first plane ‘P1’, the second plane ‘P2’, the third plane ‘P3’, and the fourth plane ‘P4’ may be parallel to one another. Further, as shown in FIG. 4, the second crests 272 of the second protrusion portions 264 correspondingly align with the first crests 256 of the first protrusion portions 248, and the second troughs 276 of the second depression portions 268 correspondingly align with the first troughs 260 of the first depression portions 252.

The second corrugated surface 228 is configured to contact a second outer surface 176′ (similar to the second outer surface 176 of the first energy storage cell 164) of the second energy storage cell 216, when the first compression pad 212 is disposed in-between the first energy storage cell 164 and the second energy storage cell 216. The second corrugated surface 228 contacts the second outer surface 176′ in a manner such that a frequency of alternating second protrusion portions 264 and the second depression portions 268 (of the second corrugated surface 228) aligns with a natural frequency of pressure distribution (not shown) (similar to the natural frequency of pressure distribution 195) across the second outer surface 176′. For example, the second protrusion portions 264 and the second depression portions 268 (of the second corrugated surface 228) are aligned, respectively, with the low-pressure and high-pressure regions (not shown) of the second outer surface 176′. Once aligned in this manner, the second protrusion portions 264 exert relatively higher loads correspondingly on the low-pressure regions and the second depression portions 268 exert relatively lower loads correspondingly on the high-pressure regions. By exerting relatively higher loads (via the second protrusion portions 264) and relatively lower loads (via the second depression portions 268), respectively, on the low-pressure regions and the high-pressure regions of the second outer surface 176′, the first compression pad 212 uniformly pressurizes the second outer surface 176′ (of the second energy storage cell 216).

Referring to FIGS. 3, 6, and 7, the second compression pads 208 are discussed. In an exemplary embodiment, the battery module 120 is provided with two second compression pads 208. For instance, as shown in FIG. 3, one of the second compression pad 208 (e.g., a second compression pad 280) is disposed between the first end plate 148 (of the housing 128) and an outermost energy storage cell 284 (of the energy storage cells 132) adjacent to the first end plate 148, and the other of the second compression pad 208 (e.g., a second compression pad 288) is disposed between the second end plate 152 (of the housing 128) and an outermost energy storage cell 292 (of the energy storage cells 132) adjacent to the second end plate 152.

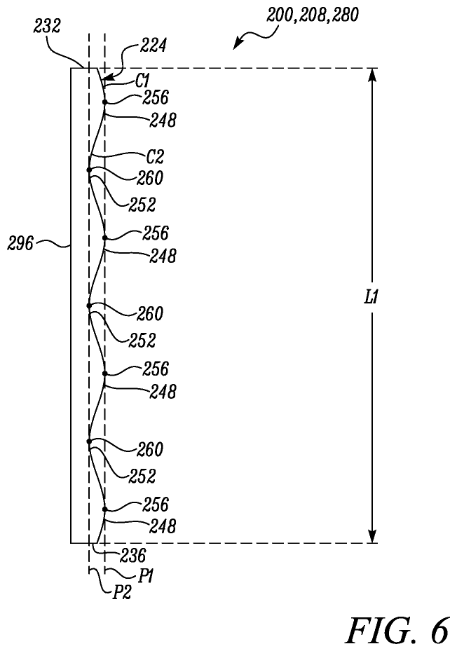

For explanatory purposes, the second compression pad 280 is discussed. However, it should be noted that the description provided below for the second compression pad 280 is equally applicable to the second compression pad 288 of the battery module 120 without any limitations. The second compression pad 280 may be similar in many respects to the first compression pad 212 but may differ from the first compression pad 212 in that one of the first corrugated surface 224 and the second corrugated surface 228 is omitted, and instead, a planar surface 296 is defined opposite to the other of the first corrugated surface 224 and the second corrugated surface 228. In an exemplary embodiment, as shown in FIG. 6, the second corrugated surface 228 of the second compression pad 280 is omitted and the planar surface 296 is defined opposite to the first corrugated surface 224. The planar surface 296 is configured to face and contact a flat face 300 of the flat end plate, i.e., the first end plate 148, of the housing 128, when the second compression pad 280 is disposed in-between the outermost energy storage cell 284 and the first end plate 148 of the housing 128.

### INDUSTRIAL APPLICABILITY

Over the course of the useful life of these energy storage cells 132, the energy storage cells 132 may swell or expand. Typically, each of the energy storage cells 132 will tend to bulge outward from its relatively larger surfaces, i.e., from the first outer surface 172 and the second outer surface 176, for example, due to a relatively low resistance along the relatively larger surfaces of the energy storage cell 132. Additionally, and/or alternatively, each of the energy storage cells 132 may swell outward from its relatively smaller surfaces, i.e., from at least one of the third outer surface 180, the fourth outer surface 184, the fifth outer surface 188, and the sixth outer surface 192. In some examples, the swelling in the relatively larger surfaces may be greater than the swelling in the relatively shorter surfaces of the energy storage cell 132. Such swelling or expansion may be due to various factors. For example, the energy storage cells 132 may expand and/or contract as the energy storage cells 132 undergoes charging and discharging processes. In another example, the energy storage cells 132 may irreversibly swell based on chemical reactions occurring within the energy storage cells 132 due to charge and discharge over the battery life of the energy storage cells 132.

To ensure ideal performance of the energy storage cells 132, extend the battery life of the energy storage cells 132, or slow the swelling of the energy storage cells 132, the energy storage cells 132 disposed within the housing 128 of the battery module 120 are compressed (pressurized, or preloaded) together under a loading. In an example, at least one flat end plates (i.e., the first end plate 148, the second end plate 152) of the housing 128 may impart the loading on the energy storage cells 132 to compress the energy storage cells 132. However, it is observed that each of these energy storage cells 132 (disposed within the housing 128) exhibits alternating high-pressure and low-pressure regions (such as the high-pressure regions 196 and the low-pressure regions 198) across its outer surfaces, i.e., the first outer surface 172 and the second outer surface 176, when compressed under the loading. To uniformly pressurize the outer surfaces of each these energy storage cells 132 compressed within the housing 128, in one or more aspects of the present disclosure, the battery module 120 is provided with the compression pads 200 (e.g., the first compression pads 204 and the second compression pads 208).

An exemplary method of controlling pressure distribution across the outer surface (e.g., the first outer surface 172) of at least one energy storage cell 132 (e.g., the first energy storage cell 164) under the loading (e.g., preload exerted by at least one of the first end plate 148 and the second end plate 152) is discussed. The method is discussed in conjunction with FIGS. 1-8. The method includes positioning the compression pad 200 within the housing 128 of the battery module 120. In an example, multiple compression pads 200 (e.g., the first compression pads 204 and the second compression pads 208) may be positioned during assembling the battery module 120. As shown in FIG. 3, each of the first compression pads 204 is disposed in-between the two neighboring energy storage cells 132. In addition, one of the second compression pad 208 (e.g., the second compression pad 280) is disposed between the first end plate 148 (of the housing 128) and the outermost energy storage cell 284 adjacent to the first end plate 148, and the other of the second compression pad 208 (e.g., the second compression pad 288) is disposed between the second end plate 152 (of the housing 128) and the outermost energy storage cell 292 adjacent to the second end plate 152.

The compression pad 200 (e.g., the first compression pad 204 and the second compression pad 208) is positioned in a manner such that its corrugated surface (e.g., the first corrugated surface 224) contacts the outer surface (e.g., the first outer surface 172) of its adjacent energy storage cell 132 and aligns with the natural frequency of pressure distribution 195 (i.e., high-pressure regions 196 and low-pressure regions 198) across the outer surface (of the energy storage cell 132). Once aligned in this manner, the protrusion portions (e.g., the first protrusion portions 248) of the compression pad 200 may exert relatively higher loads correspondingly on the low-pressure regions 198 and the depression portions (e.g., the first depression portions 252) of the compression pad 200 may exert relatively lower loads correspondingly on the high-pressure regions 196. By exerting relatively higher loads (via the protrusion portions) and relatively lower loads (via the depression portions), respectively, on the low-pressure regions 198 and the high-pressure regions 196 of the outer surface (e.g., the first outer surface 172) of the energy storage cell 132, the compression pad 200 uniformly pressurizes the outer surface of the energy storage cell 132 under the loading, as shown in FIG. 8. By uniformly pressurizing the outer surfaces of each energy storage cell 132 using the compression pads 200, performance of the energy storage cells 132 may be improved, battery life of the energy storage cells 132 may be extended, and/or the swelling of the energy storage cells 132 may be slowed.

In some embodiments, in which the energy storage cell 132 (or the energy storage cell 164) exhibits vertical pressure variations, i.e., alternating high pressure regions and low-pressure regions across the width ‘w’ of the first outer surface 172 under the loading, the compression pad 212 may be positioned in a manner such its protrusion portions and the depression portions may, respectively, align with the high-pressure regions and the low-pressure regions across the width ‘w’ of the first outer surface 172.

In other embodiments, the compression pad 212 may include a corrugated surface with alternating protrusion and depression portions defined in desired sizes and patterns to inversely mirror the observed natural frequency of pressure distributions on the outer surface (e.g., the first outer surface 172) of the energy storage cell 132. In an example, in which the energy storage cell 132 exhibits alternating high pressure regions and low-pressure regions across both the length ‘l’ and the width ‘w’ of the first outer surface 172 under the loading, the compression pad 212 having a corrugated surface with protrusion and depression portions arrayed alternately along both the length ‘L1’ and the width ‘W1’ of the corrugated surface may be selected.

In another example, the first plane ‘P1’ (on which the first crests 256 are defined), the second plane ‘P2’ (on which the first troughs 260 are defined), the third plane ‘P3’ (on which the second crests 272 are defined), and the fourth plane ‘P4’ (on which the second trough 276 are defined) may not be parallel to one another. In yet another example, the size (e.g., height, depth, width, etc.,) of the first protrusion portions 248 and the first depression portions may vary across at least one of the lengths ‘L1’ or ‘L2’ and/or the width ‘W1’ of the compression pad 212 based on variation in magnitude of the pressure observed across the outer surface (e.g., the first outer surface 172) of the energy storage cell 132 under the loading.

Unless explicitly excluded, the use of the singular to describe a component, structure, or operation does not exclude the use of plural such components, structures, or operations or their equivalents. The use of the terms “a” and “an” and “the” and “at least one” or the term “one or more,” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B” or one or more of A and B”) is to be construed to mean one item selected from the listed items (A or B) or any combination of two or more of the listed items (A and B; A, A and B; A, B and B), unless otherwise indicated herein or clearly contradicted by context. Similarly, as used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

It will be apparent to those skilled in the art that various modifications and variations can be made to the compression pad, the battery module, and/or the method of the present disclosure without departing from the scope of the disclosure. Other embodiments will be apparent to those skilled in the art from consideration of the specification and practice of the compression pad, the battery module, and/or the method disclosed herein. It is intended that the specification and examples be considered as exemplary only, with a true scope of the disclosure being indicated by the following claims and their equivalent.

What is claimed is:

1. A compression pad for pressurizing an outer surface of at least one energy storage cell exhibiting alternating high-pressure and low-pressure regions across the outer surface under a loading, the compression pad comprising:
a body defining a corrugated surface including alternating protrusion portions and depression portions,
wherein the corrugated surface is configured to contact the outer surface and align with a natural frequency of pressure distribution across the outer surface such that the protrusion portions exert relatively higher loads correspondingly on the low-pressure regions and the depression portions exert relatively lower loads correspondingly on the high-pressure regions to uniformly pressurize the outer surface under the loading.

2. The compression pad of claim 1, wherein the protrusion portions define corresponding first crests in a first plane and the depression portions define corresponding first troughs in a second plane.

3. The compression pad of claim 2, wherein the first plane and the second plane are parallel to each other.

4. The compression pad of claim 1, wherein the outer surface is a first outer surface, and the corrugated surface is a first corrugated surface including alternating first protrusion portions and first depression portions, and wherein:
the body defines a second corrugated surface including alternating second protrusion portions and second depression portions, the second corrugated surface is defined opposite to the first corrugated surface to contact a second outer surface of another energy storage cell and align with a natural frequency of pressure distribution across the second outer surface to uniformly pressurize the second outer surface under the loading.

5. The compression pad of claim 4, wherein the second protrusion portions define corresponding second crests in a third plane and the second depression portions define corresponding second troughs in a fourth plane.

6. The compression pad of claim 5, wherein the third plane and the fourth plane are parallel to each other.

7. The compression pad of claim 5, wherein the first crests of the first protrusion portions correspondingly align with the second crests of the second protrusion portions, and wherein the first troughs of the first depression portions correspondingly align with the second troughs of the second depression portions.

8. The compression pad of claim 1, wherein the body defines a planar surface opposite to the corrugated surface, the planar surface is configured to face and contact a flat end plate of a housing accommodating the at least one energy storage cell under the loading.

9. The compression pad of claim 1, wherein the body is fabricated from polyurethane material.

10. A battery module for a work machine, the battery module comprising:
a housing;
at least one energy storage cell disposed within the housing, the at least one energy storage cell defining an outer surface and exhibiting alternating high-pressure and low-pressure regions across the outer surface under a loading; and
a compression pad for pressurizing the outer surface under the loading, the compression pad including:
a body defining a corrugated surface including alternating protrusion portions and depression portions,
wherein the corrugated surface is configured to contact the outer surface and align with a natural frequency of pressure distribution across the outer surface such that the protrusion portions exert relatively higher loads correspondingly on the low-pressure regions and the depression portions exert relatively lower loads correspondingly on the high-pressure regions to uniformly pressurize the outer surface under the loading.

11. The battery module of claim 10, wherein the protrusion portions define corresponding first crests in a first plane and the depression portions define corresponding first troughs in a second plane, and wherein the first plane and the second plane are parallel to each other.

12. The battery module of claim 11, wherein the outer surface is a first outer surface, and the corrugated surface is a first corrugated surface including alternating first protrusion portions and first depression portions, and wherein:
the body defines a second corrugated surface including alternating second protrusion portions and second depression portions, the second corrugated surface is defined opposite to the first corrugated surface to contact a second outer surface of another energy storage cell disposed within the housing and align with a natural frequency of pressure distribution across the second outer surface to uniformly pressurize the second outer surface under the loading.

13. The battery module of claim 12, wherein the second protrusion portions define corresponding second crests in a third plane and the second depression portions define corresponding second troughs in a fourth plane, and wherein the third plane and the fourth plane are parallel to each other.

14. The battery module of claim 13, wherein the first crests of the first protrusion portions correspondingly align with the second crests of the second protrusion portions, and wherein the first troughs of the first depression portions correspondingly align with the second troughs of the second depression portions.

15. The battery module of claim 10, wherein the housing defines a flat end plate, and wherein the body defines a planar surface opposite to the corrugated surface, the planar surface is configured to face and contact the flat end plate under the loading.

16. The battery module of claim 10, wherein the body of the compression pad is fabricated from polyurethane material.

17. The battery module of claim 10, wherein the at least one energy storage cell is one of a pouch cell or a prismatic cell.

18. A method for controlling pressure distribution across an outer surface of at least one energy storage cell of a battery module, the at least one energy storage cell exhibiting alternating high-pressure and low-pressure regions across the outer surface under a loading, the method comprising:
positioning a compression pad within the battery module, the compression pad including a body defining a corrugated surface including alternating protrusion portions and depression portions,
wherein the compression pad is positioned in a way that the corrugated surface contacts the outer surface and aligns with a natural frequency of pressure distribution across the outer surface such that the protrusion portions exert relatively higher loads correspondingly on the low-pressure regions and the depression portions exert relatively lower loads correspondingly on the high-pressure regions to uniformly pressurize the outer surface under the loading.

19. The method of claim 18, wherein the outer surface is a first outer surface, and the corrugated surface is a first corrugated surface including alternating first protrusion portions and first depression portions,
wherein the body defines a second corrugated surface including alternating second protrusion portions and second depression portions, the second corrugated surface is defined opposite to the first corrugated surface, and
wherein the compression pad is positioned such that the second corrugated surface contacts a second outer surface of another energy storage cell disposed within the housing and aligns with a natural frequency of pressure distribution across the second outer surface to uniformly pressurize the second outer surface under the loading.

20. The method of claim 18, wherein the battery module includes a housing configured to accommodate the at least one energy storage cell therein, the housing defines a flat end plate,
wherein the body defines a planar surface opposite to the corrugated surface, and
wherein the compression pad is positioned between the at least one energy storage cell and the flat end plate such that the planar surface faces and contacts the flat end plate under the loading.
